(19) United States
(12) Patent Application Publication
(10) Pub. No.: US 2005/0176428 A1
(43) Pub. Date: Aug. 11, 2005

(54) Controlling communication sessions in a communication system

(75) Inventors: Jaro Gabor, Budapest (HU); Bajko Gabor, Budapest (HU)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/839,346

(22) Filed: May 6, 2004

(30) Foreign Application Priority Data
Feb. 10, 2004 (GB) GB0402894.0

(51) Int. Cl. H04Q 7/20

(52) U.S. Cl. 455/435.1; 455/561

(57) ABSTRACT

There is disclosed a method in a communication system comprising a serving entity for providing services to at least one user, and in which access to said serving entity is established via an intermediate entity, the method comprising: registering a user with the serving entity; and selectively de-registering said user from the serving entity under the control of the intermediate entity.

### BACKGROUND OF THE INVENTION

1. Field of the Invention

The present invention relates to communication systems, and in particular, to control of communication sessions in a system wherein at least one proxy controller entity may be used when providing a user equipment with communication resources.

2. Description of the Related Art

A communication system can be seen as a facility that enables communication sessions between two or more entities such as user equipment and/or other nodes associated with the communication system. The communication may comprise, for example, communication of voice, data, multimedia and so on. A user equipment may, for example, be provided with a two-way telephone call or multi-way conference call. A user equipment may also be provided with a connection to an application providing entity, for example to an application server (AS), thus enabling use of services provided by the application server.

A communication system typically operates in accordance with a given standard or specification which sets out what the various entities associated with the communication system are permitted to do and how that should be achieved. For example, the standard or specification may define if the user, or more precisely, user equipment is provided with a circuit switched service and/or a packet switched service. Communication protocols and/or parameters which shall be used for the connection may also be defined. In other words, a specific set of “rules” on which the communication can be based on needs to be defined to enable communication by means of the system.

Communication systems providing wireless communication for user equipment are known. An example of a wireless system is the public land mobile network (PLMN). Another example is a mobile communication system that is based, at least partially, on use of communication satellites. Wireless communications may also be provided by means of other arrangements, such as by means of wireless local area networks (WLAN). Communication on the wireless interface between the user equipment and the elements of the communication network can be based on an appropriate communication protocol. The operation of the station apparatus of the communication system and other apparatus required for the communication can be controlled by one or several control entities. The various control entities may be interconnected. One or more gateway nodes may also be provided for connecting a communication network to other networks. For example, a mobile network may be connected to communication networks such as an IP (Internet Protocol) and/or other packet switched data networks.

An example of the services that may be offered for users of a communication system is the so called multimedia services. An example of the communication systems enabled to offer multimedia services is the Internet Protocol (IP) Multimedia network. IP Multimedia (IM) functionalities can be provided by means of a IP Multimedia Core Network (CN) subsystem, or briefly IP Multimedia subsystem (IMS). The IMS includes various network entities for the provision of the multimedia services.

The Third Generation Partnership Project (3GPP) has defined use of the General Packet Radio Service (GPRS) as a backbone communication system for the provision of the IMS services, the GPRS being given herein as a non-limiting example of a possible backbone communication system enabling the multimedia services. The Third Generation Partnership Project (3GPP) has also defined a reference architecture for the third generation (3G) core network which will provide the users of user equipment with access to the multimedia services. This core network is divided into three principal domains. These are the Circuit Switched (CS) domain, the Packet Switched (PS) domain and the Internet Protocol Multimedia (IM) domain.

The latter of these, the IM domain, is for ensuring that multimedia services are adequately managed. The 3G IM domain supports the Session Initiation Protocol (SIP) as developed by the Internet Engineering Task Force (IETF). Session Initiation Protocol (SIP) is an application-layer control protocol for creating, modifying and terminating sessions with one or more participants (endpoints).

Before a user equipment is able to communicate with an IM CN subsystem, a GPRS attach procedure must be performed and a communication channel known as a Packet Data Protocol (PDP) context for SIP signalling must be established. The PDP context is established towards the GGSN in the home or visited network. The PDP context will provide the user equipment with an appropriate IP address. This address may then serve as the host address for the duration of the PDP context. The PDP context where the SIP signalling is performed must be available as long as services from the IM CN subsystem are wanted. This requirement is not limited to GPRS access and PDP contexts, but may apply also to other types of access systems and communication channels.

The communication systems have developed in the direction wherein various functions of the network are handled by appropriate controller entities. A user may access services via a data network via a chain of controllers. These controllers are typically provided by means of servers. IMS specifications define different kinds of SIP servers via which services may be accessed. These controllers provide functions such as the call session control functions (CSCFs). It shall be appreciated that the CSCFs may be also referenced to as the call state control functions.

The call session functions may be divided into various categories such as a proxy call session control function (P-CSCF), interrogating call session control function (I-CSCF), and serving call session control function (S-CSCF). The user needs to be registered at the serving call session control function (S-CSCF) in order to be able to request for a service from the communication system. A proxy call session control function (P-CSCF) in turn, is for proxying communications between a user and a serving call session control function (S-CSCF) the user is registered with. In other words, after registration to an IMS data network a user has a registrar (S-CSCF) assigned and an outbound proxy (typically a P-CSCF) which acts as a proxy from a registration point of view. Any activity of the user goes through these data network controller entities.

IMS registration therefore involves two fully stateful servers: the serving call session control function and the proxy call session control function. The registration must be fully successful (or unsuccessful) end-to-end, so that all parties, the user and the two stateful servers, have a consistent state for the registration. The user will receive a registration response, following a registration process, and assumes both of the stateful servers to have that registration state, which will be either registered or unregistered. This consistency between the user equipment, the proxy CSCF and the serving CSCF is important for correct communication. However, there exists certain error conditions under which the states of the user equipment, the proxy CSCF and the serving CSCF may be inconsistent.

During user initiated registration, the S-CSCF sends a confirmation response message to the user equipment, which indicates to the user equipment that the user has been successfully registered into the S-CSCF. However, it may occur that the P-CSCF cannot store the registration status itself, for example due to a database problem, an overload problem, a protocol/software error, etc. The P-CSCF may then send either a confirmation response message towards the user equipment or an error code towards the user equipment. However in both cases this will result in an inconsistency between the registration status in the user equipment, the proxy CSCF, and the serving CSCF. If the user gets a confirmation response to its registration request from the serving CSCF, the user will assume that the registration is successful and it considers that sessions can be initiated and terminated. However, the user cannot initiate sessions and cannot terminate a session, because the proxy CSCF does not have the required information about the user in its database, such as for example security information. If, alternatively, an error response is sent to the user equipment by the proxy CSCF, the user considers that the whole registration is unsuccessful, and will expect that the serving CSCF will execute the services only for an unregistered user, for example voicemail. However because the serving CSCF thinks that the user is registered, all terminating requests will be sent towards the user, and because the user is not present in the proxy CSCF databases, the terminating request will be refused by the proxy CSCF. Thus such request would not reach the user.

In a second problem case, an already successfully registered user might be required to be de-registered from the proxy CSCF. This may, for example, be due to a local policy change, such as where the proxy CSCF is in the visited network, and a different policy is applied by the proxy and serving CSCFs. Other reasons may give rise to this eventuality, such as the user or a group of users being de-registered from a particular proxy CSCF. Where the proxy CSCF initiates such de-registration, similar problems to those described above exist, and the serving CSCF no longer has a consistent record of the state of the registration, considering the registration to still be registered when the proxy CSCF has de-registered the user.

### SUMMARY OF THE INVENTION

Embodiments of the present invention aim to address one or several of the above problems.

According to one aspect the invention provides a method in a communication system comprising a serving entity for providing services to at least one user, and in which access to said serving entity is established via an intermediate entity, the method comprising: registering a user with the serving entity; and selectively de-registering said user from the serving entity under the control of the intermediate entity.

The step of de-registering said user may include transmitting a de-registration message from the intermediate entity to the serving entity. Responsive to the de-registration message the serving entity may remove the registration of the user from the serving entity. Responsive to removal of the registration from the server entity the server entity may transmit an acknowledgment to the intermediate entity.

The method may further include the step of, following the registration of the user with the serving entity, receiving confirmation of such registration at the intermediate entity; and responsive thereto initiating registration of the user at the intermediate entity, the step of selectively de-registering said user is enabled dependent upon a failed registration with the intermediate entity.

Responsive to enabling the step of selectively de-registering said user the intermediate element may transmit a message to the user indicating a failed registration.

The method may further include the step of, following successful registration with the intermediate entity, enabling the step of selectively de-registering said user dependent upon a determination that the user's registration at the intermediate entity is to be terminated.

Said determination may be dependent upon a local change in a network with which the intermediate element is associated.

Responsive to the step of enabling the step of selectively de-registering said user the intermediate element may transmit a de-registration message to the serving entity. Responsive thereto the serving entity may de-register the user. Responsive thereto the serving entity may transmit a notification of de-registration to the user. Responsive thereto the serving entity may receive an acknowledgement from the user. Responsive thereto the serving entity may transmit an acknowledgement of de-registration to the intermediate entity.

The intermediate entity may be a proxy call session control function and the serving entity may be a serving call session control function. The messages between the intermediate element and the serving element may be session initiation protocol messages. The determination that the user's registration at the intermediate entity may be terminated determines termination of a plurality of user's registration.

The step of registering the user with the serving entity may include a step of receiving a registration request from the intermediate entity at the serving entity, the de-registering step being dependent upon said de-registration message and said registration message originating from the same intermediate entity.

In a further aspect the invention provides an intermediate entity for a communication system comprising a serving entity for providing services to at least one user, and in which access to said serving entity is established via the intermediate entity, comprising: means for determining non-registration of a user at the intermediate entity; and means for transmitting a de-registration message to the serving entity responsive thereto.

The intermediate entity may further include means for receiving confirmation of the registration of the user from the serving entity, and means responsive thereto to initiate registration of the user with the intermediate element, wherein said means for determining non-registration of a user is responsive to failure of said initiated registration.

The intermediate entity may further include means for transmitting a registration failure message to the user responsive to the failure of said initiated registration.

The intermediate entity may further including means for receiving, at the intermediate node, a notification to de-register the user from the intermediate node, wherein said means for determining non-registration of a user is responsive to said notification.

The intermediate element may comprise a proxy call session control function.

In another aspect the invention provides a communication system including at least one serving entity for providing services to at least one user, and at least one intermediate entity for providing access to said at least one server entity for said at least one user, the intermediate entity being adapted to initiate de-registration of the user in the serving entity.

Said intermediate entity may be adapted to initiate de-registration of the user in the serving entity responsive to a failed registration of the user in the intermediate entity. Said intermediate entity may be adapted to initiate de-registration of the user in the serving entity responsive to a decision to terminate the registration of the user in the intermediate entity. The intermediate server may be adapted to receive said decision from a network control element.

The intermediate element and the serving entity may belong to different networks. The intermediate element may be a proxy call session control function and the serving entity may be a serving call state control function.

In a still further aspect the invention provides a method in a communication system comprising at least one user and a serving entity for said user, and in which a connection between said user and said serving entity is established via an intermediate entity, the method comprising: transmitting a registration request from the user to the serving entity via the intermediate entity; registering the user at the serving entity; transmitting confirmation of the user registration from the serving entity to the intermediate entity; and responsive to a failed registration at the intermediate entity, transmitting a de-registration message for the user to the serving entity.

The method may further comprise, responsive to a failed registration at the intermediate entity, transmitting an indication of unsuccessful registration to the user.

In yet a further aspect the invention provides a method in a communication system comprising at least one user and a serving entity for said user, and in which a connection between said user and said serving entity is established via an intermediate entity, the method comprising: establishing a registration for the user at the serving entity via the intermediate entity; determining, at the intermediate entity, that the user's registration is to be terminated; and transmitting a de-registration message for the user from the intermediate entity to the serving entity.

Responsive to the de-registration message the serving entity may transmit a notification of the de-registration to the user. Responsive to the de-registration message to the user the serving entity transmits a notification of the de-registration to the intermediate entity.

### BRIEF DESCRIPTION OF THE DRAWINGS

For a better understanding of the present invention, reference will now be made by way of example to the accompanying drawings in which:

FIG. 1 shows a communication system environment within which the invention can be embodied;

FIG. 2 shows a messaging flow illustrating a first problem which the invention is directed to;

FIG. 3 shows a messaging flow illustrating a second problem which the invention is directed to;

FIG. 4 shows a messaging flow in a first embodiment of the invention; and

FIG. 5 shows a messaging flow in a second embodiment of the invention.

### DETAILED DESCRIPTION OF THE PREFERRED EMBODIMENTS

Certain embodiments of the present invention will be described in the following by way of example, with reference to the exemplifying architecture of a third generation (3G) mobile communications system. However, it shall be appreciated that the embodiments may be applied to any suitable communication system.

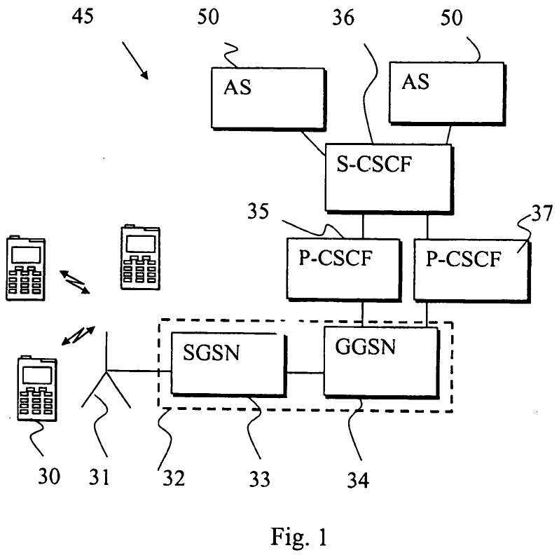

Reference is made to FIG. 1 which shows an example of a network architecture in which the invention may be embodied. In FIG. 1 an IP Multimedia Network 45 is provided for offering IP multimedia services for IP Multimedia Network subscribers.

As described above, access to IP Multimedia (IM) services can be provided by means of a mobile communication system. A mobile communication system is typically arranged to serve a plurality of mobile user equipment usually via a wireless interface between the user equipment and at least one base station 31 of the communication system. The mobile communication system may logically be divided between a radio access network (RAN) and a core network (CN).

The base station 31 is arranged to transmit signals to and receive signals from a mobile user equipment 30 via a wireless interface between the user equipment and the radio access network. Correspondingly, the mobile user equipment 30 is able to transmit signals to and receive signals from the radio access network via the wireless interface.

In the shown arrangement the user equipment 30 may access the IMS network 45 via the access network associated with the base station 31. It shall be appreciated that, although, for clarity reasons FIG. 1 shows a base station of only one radio access network, a typical communication network system usually includes a number of radio access networks.

The 3G radio access network (RAN) is typically controlled by an appropriate radio network controller (RNC). This controller is not shown in order to enhance clarity. A controller may be assigned for each base station or a controller can control a plurality of base stations, for example in the radio access network level. It shall be appreciated that the name, location and number of the radio network controllers depends on the system.

The mobile user equipment 30 of FIG. 1 may comprise any appropriate mobile user equipment adapted for Internet Protocol (IP) communication to connect to the network. For example, the mobile user may access the cellular network by means of a Personal computer (PC), Personal Data Assistant (PDA), mobile station (MS) and so on. The following examples are described with reference to mobile stations.

One skilled in the art is familiar with the features and operation of a typical mobile station. Thus, it is sufficient to note that the user may use a mobile station for tasks such as for making and receiving phone calls, for receiving and sending data from and to the network and for experiencing multimedia content or otherwise using multimedia services. A mobile station may include an antenna for wirelessly receiving and transmitting signals from and to base stations of the mobile communication network. A mobile station may also be provided with a display for displaying images and other graphical information for the user of the mobile user equipment. Camera means may be provided for capturing still or video images. Speaker means are also typically provided. The operation of a mobile station may be controlled by means of an appropriate user interface such as control buttons, voice commands and so on. Furthermore, a mobile station is provided with a processor entity and a memory means.

It shall be appreciated that although only a few mobile stations are shown in FIG. 1 for clarity, a great number of mobile stations may be in simultaneous communication with a communication system.

A core network (CN) typically includes various switching and other control entities and gateways for enabling the communication via a number of radio access networks and also for interfacing a single communication system with one or more communication systems such as with other cellular systems and/or fixed line communication systems. In 3GPP systems the radio access network is typically connected to an appropriate core network entity or entities such as, but not limited to, a serving general packet radio service support node (SGSN) 33. The radio access network is in communication with the serving GPRS support node via an appropriate interface, for example on an lu interface. The serving GPRS support node, in turn, typically communicates with an appropriate gateway, for example a gateway GPRS support node 34 via the GPRS backbone network 32. This interface is commonly a switched packet data interface.

In a 3GPP network, a packet data session is established to carry traffic flows over the network. Such a packet data session is often referred as a packet data protocol (PDP) context. A PDP context may include a radio bearer provided between the user equipment and the radio network controller, a radio access bearer provided between the user equipment, the radio network controller and the SGSN 33, and switched packet data channels provided between the serving GPRS service node 33 and the gateway GPRS service node 34. Each PDP context usually provides a communication pathway between a particular user equipment and the gateway GPRS support node and, once established, can typically carry multiple flows. Each flow normally represents, for example, a particular service and/or a media component of a particular service. The PDP context therefore often represents a logical communication pathway for one or more flow across the network. To implement the PDP context between user equipment and the serving GPRS support node, at least one radio access bearer (RAB) needs to be established which commonly allows for data transfer for the user equipment. The implementation of these logical and physical channels is known to those skilled in the art and is therefore not discussed further herein.

FIG. 1 shows also a plurality of application servers 50 connected to the exemplifying Internet Protocol (IP) Multimedia network 45. The user equipment 30 may connect, via the GPRS network 32 and an IMS network 45, to at least one of the application servers 50. It shall be appreciated that a great number of application servers may be connected to a data network.

Communication with the application servers is controlled by means of functions of the data network that are provided by appropriate controller entities. For example, in the current third generation (3G) wireless multimedia network architectures it is assumed that several different servers providing various control functions are used for the control. These include functions such as the call session or call state control functions (CSCFs). The call session functions may be divided into various categories. FIG. 1 shows proxy call session control functions (P-CSCF) 35 and 37 and a serving call session control function (S-CSCF) 36. It shall be appreciated that similar functions may be referred to in different systems with different names.

A user who wishes to use services provided by an application server via the IMS system may need first to register with a serving controller, such as the serving call session control function (S-CSCF) 36. The registration is required to enable the user equipment to request a service from the multimedia system. As shown in FIG. 1, communication between the S-CSCF 36 and the user equipment 30 may be routed via at least one proxy call session control function (P-CSCF) 35. The proxy CSCF 35 thus acts as a proxy which forwards messages from the GGSN 34 to a serving call session control function 36 and vice versa.

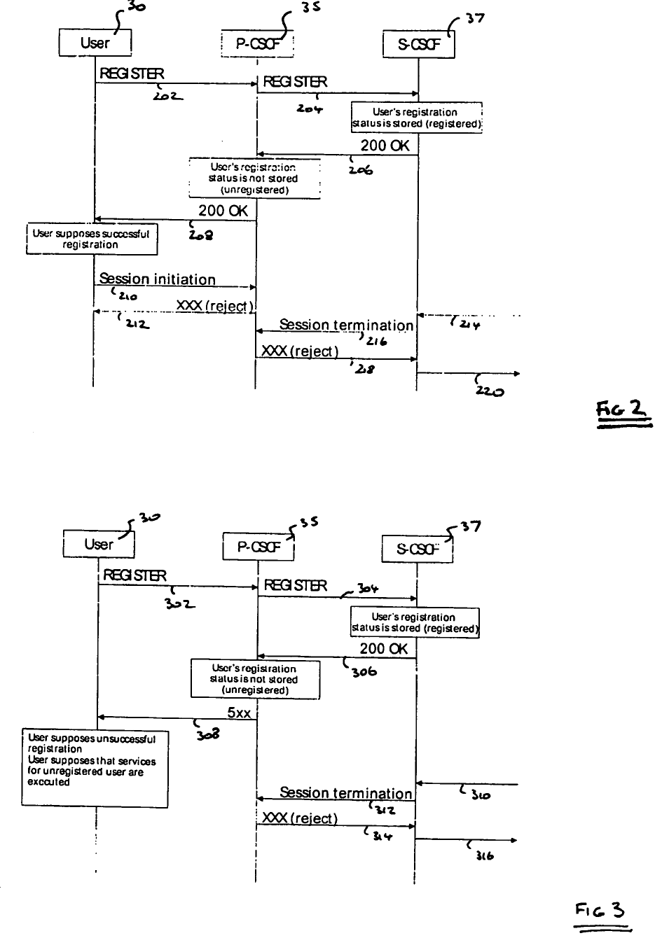

Referring to FIG. 2, there is illustrated the steps in the registration process between the user equipment 30, the proxy CSCF 35, and the serving CSCF 37. It should be noted that FIG. 2 illustrates an exemplary arrangement for illustration purposes. The user equipment 30 initiates the registration process by sending a message 202 comprising a request for registration. This request for registration message is received by the proxy CSCF 35. The proxy CSCF 35 in turn forwards a registration request, on behalf of the user equipment 30, by way of a message 204 to the serving CSCF 37.

Following receipt of the registration request message 204, the serving CSCF accepts the registration and stores details of the user's registration therein, with a status denoting that the user is a registered user. The serving CSCF 37 then returns an acknowledgement message 206 to the proxy CSCF 35, which confirms successful registration.

On receipt of the acknowledgement message 206, the proxy CSCF 35 does not—in this example—store the status of the registration itself, for example because of a database problem. The proxy CSCF 35 nevertheless forwards an acknowledgement message 208 to the user equipment 30, indicating successful registration.

Thereafter the user equipment 30 supposes that successful registration has taken place, and assumes that each of the proxy CSCF 35 and the serving CSCF 37 have stored the registration therein.

However, as noted, the proxy CSCF 35 has in fact not stored the registration, and thus considers the user equipment 30 to be unregistered.

Thereafter, on the assumption that registration has been successful, the user equipment 30 may initiate a session with a message 210 toward the proxy CSCF 35. The proxy CSCF 35 does not recognise the user equipment 30 as a registered user, and therefore returns an error message 212 to the user equipment, by way of a rejection of the session initiation. Similarly, the serving CSCF 37 may receive a terminating request for the user equipment 30 as a message 214, and considering the user equipment to be registered forward a session termination message 216 to the proxy CSCF 35. The proxy CSCF 35 then sends a rejection message 218 to the serving CSCF 37, as the user equipment is not registered with the proxy CSCF 35. The serving CSCF then returns an appropriate rejection message 220 toward the originator of the terminating request.

Thus, FIG. 2 illustrates the problem caused by inconsistent states between the user equipment 30, the proxy call state control function 35, and the serving call state control function 37, where the proxy CSCF does not register the user status during a registration process, despite indicating to the user equipment 30, and the serving CSCF 37, that registration has taken place.

A further problem is illustrated with reference to FIG. 3.

As in FIG. 2, the user equipment 30 forwards a registration request message 302 to the proxy CSCF 35, which in turn forwards a registration request message 304 to the serving CSCF 37. Responsive to the registration request message 304, the serving CSCF 37 successfully registers the user equipment, and returns an acknowledgement message 306 confirming successful registration.

In the example of FIG. 3, the proxy CSCF 35 is again unable to store the registration status of the user equipment, for example due to a database problem. However whereas in FIG. 2, the proxy CSCF 35 still returned an acknowledgement of successful registration to the user equipment, in FIG. 3 the proxy CSCF 35 returns an error message 308 to the user equipment.

As such, the user equipment 310 supposes that unsuccessful registration has taken place, and that only services for an unregistered user will be executed.

However, once again, the stored state of each of the three elements in FIG. 3 is inconsistent, the serving CSCF 37 considering the registration to be completed successfully, the proxy CSCF not having stored the registration, and the user equipment 30 considering the registration to be unsuccessful.

Thereafter the serving CSCF 37 receives a terminating request 310, and identifying the user equipment as being registered forwards a session termination message 312 to the proxy CSCF 35. The proxy CSCF 35 does not identify the user as a registered user, and returns a rejection message 314 to the serving CSCF 37, which in turn returns an appropriate message 316 to the originator of the terminating request.

Thus, FIGS. 2 and 3 illustrate the problem associated with maintaining consistency of the registration status in the proxy CSCF, serving CSCF, and user equipment.

It should be noted that whilst the invention is described specifically with reference to a serving CSCF and a proxy CSCF by way of example, more generally the invention applies to an environment where a serving entity is provided, which is accessed via an intermediate entity. In the examples described, the intermediate entity is the P-CSCF and the serving entity so the S-CSCF.

It should be noted that the problem may arise due to the proxy CSCF 35 not registering the user equipment due to any situation. Although the example is given of a database problem occurring in the proxy CSCF, other errors or circumstances may cause failure of the registration. For example there may be a protocol/software error, or there may be an overload within the proxy CSCF 35.

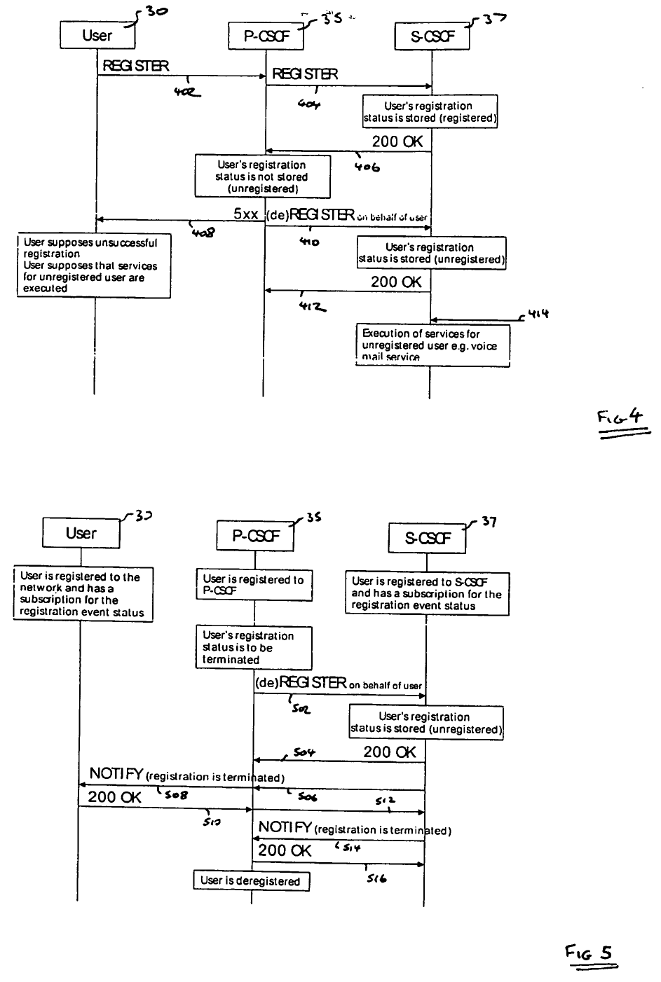

Referring to FIG. 4, there is illustrated a technique for ensuring consistent status across the various elements in accordance with an embodiment of the invention.

As before, a registration is initiated by the user sending a registration request message 402 to the proxy CSCF 35, which in turn forwards a registration request message 404 to the serving CSCF 37. The serving CSCF 37 then accepts and stores the user's registration.

The serving CSCF 37 then returns an acknowledgement message 406, acknowledging successful registration, to the proxy CSCF 35. In the case where the proxy CSCF 35 is unable to store the user's registration, the proxy CSCF 35 then transmits two messages.

Firstly, the proxy CSCF 35 transmits an error message 408 to the user equipment 30. Secondly, the proxy CSCF 35 transmits a de-registration message 410 to the serving CSCF 37. The de-registration message instructs the serving CSCF to de-register the user equipment. It should be noted that the messages 408 and 410 may be sent simultaneously, or one may be sent in advance of the other. The order of sequence of transmission of such messages is not important.

Thereafter, the serving CSCF 37, responsive to the de-registration message 410, changes the status of the user equipment to unregistered therein, and transmits an acknowledgement message 412 of such action to the proxy CSCF 35.

After receipt of the error message 408, the user assumes that the registration has been unsuccessful, and that services for an unregistered user only will be executed. After receipt of the de-registration message 410, and subsequent removal of the user equipment from its list of registered users, the serving CSCF 37 may receive a message 414 toward the user equipment 30. The serving CSCF 37 only processes services for unregistered users, for example voicemail services, toward the user equipment 30.

Thus, in the event of any problem that prevents the storing of user registration related information into the proxy CSCF, the proxy CSCF rejects the registration towards the user equipment. The rejection may include an appropriate response code, in accordance with the standards associated with the communication system implemented. The proxy CSCF additionally sends a de-registration message on behalf of the user equipment to the serving CSCF, in order to re-synchronise the registration status of the three elements. Thus the registration status of the user will be consistent in the proxy CSCF, serving CSCF, and the user equipment as unregistered or de-registered. The de-registration message sent from the proxy CSCF to the serving CSCF may be considered to be a specific type of registration message.

In a preferred embodiment, only the same proxy CSCF that was involved in the initial registration of the user is allowed to de-register the user in the serving CSCF.

The de-registration message contains the address of the proxy CSCF as a source address (for example, in the ‘from’ header in a SIP REGISTER message). This address preferably is the same one which was inserted into the ‘path’ header during a user initiated registration via the proxy CSCF. The serving CSCF may then only accept the 3^{rd} party de-registration if the sender responsible for the registration message is the same proxy CSCF via which the initial registration was done.

A further embodiment implementing the techniques of the invention is described with reference to FIG. 5. In FIG. 5, it is initially assumed that the user equipment 30 is registered in the network, and has a subscription for a registration event status. Similarly, the proxy CSCF 35 contains a registration of the user associated with the user equipment 30. The serving CSCF 37 also includes a registration of the user, and has a subscription for registration event status. Thus each of the user equipment 30, the proxy CSCF 35, and the serving CSCF 37 have a consistent status, the status being “registered”.

At some point after the registration, the proxy CSCF 35 determines that the user's registration status is to be terminated. This may, for example, be because of a local policy change, such that the proxy CSCF is in the visited network, and a different policy may be applied between the proxy CSCF and serving CSCF, such that the reasons for the proxy CSCF terminating the user's registration are not known and are not common to the serving CSCF. Other reasons may result in the proxy CSCF terminating the user's registration. The proxy CSCF 35 may not just terminate a single user's registration, but may terminate the registration of a group of users, or of all users connected therethrough. Thus, an already successfully registered user might be required to be de-registered from the proxy CSCF.

In accordance with this embodiment of the invention, the proxy CSCF 35 transmit a de-registration message 502 on behalf of the user to the serving CSCF 37. The serving CSCF 37 then acts on such de-registration message, and stores the user's registration status as unregistered. The serving CSCF 37 then returns an acknowledged message 504 to the proxy CSCF 35, confirming de-registration.

If the user has a subscription for a registration event status with the serving CSCF, then on the registration the serving CSCF 37 may transmit a notification message 506 to the proxy CSCF 35 which is in turn forwarded as a notification message 508 to the user equipment 30, notifying the user that the registration has been terminated. Responsive thereto, the user equipment 30 may return an acknowledgement message 510 to the proxy CSCF 35, which is in turn forwarded as an acknowledgement message 512 to the serving CSCF 37.

Thereafter, the serving CSCF 37 may forward a notification message 514 to the proxy CSCF 35 confirming to the proxy CSCF that registration has been terminated for the user. The proxy CSCF 35 may then return an acknowledgement message 516 to the serving CSCF 37.

After such sequence of message exchanges, the user is de-registered in all elements.

It should be noted, in the example of FIG. 5, that following the decision to de-register a user equipment, the proxy CSCF may in addition to sending the de-registration message 502 to the serving CSCF 37, send a notification directly to the user equipment 30 that the registration is terminated. There may be no communication between the serving CSCF 37 and the user equipment 30 in this process.

After being notified of unsuccessful registration, such as in the example of FIG. 4, or after being notified of de-registration, such as in the example of FIG. 5, the user equipment may start a proxy CSCF discovery procedure, and send the new registration request to the network. There are various possibilities for the discovery procedure. Two examples are described below.

In the first example the access network is provided by means of a GPRS network. A proxy controller, in this example a Proxy-CSCF, discovery may be performed by means of a mechanism that is based on Dynamic Host Configuration Protocol (DHCP). The DHCP may be used for obtaining address information for any SIP servers, and may thus be used for obtaining appropriate P-CSCF address information, and also appropriate domain name service (DNS) server information, if required. In operation of this example, an appropriate PDP context bearer may first be established by using an appropriate PDP context establishment procedure. The user equipment may then send a request for address information to a DHCP server. The user equipment may request for a list of fully qualified domain names of P-CSCFs and the IP addresses of DNS servers. Alternatively, the user equipment may request for a list of P-CSCF IP addresses. DHCP Query/Response message exchange may be required to retrieve the requested information. DNS Query/Response may then be performed between the user equipment and the DNS server.

If P-CSCF address information is not received in a DHCP response, and the transport protocol and port number are not known to the user equipment, the user equipment may query for the domain returned in the DHCP response to select the transport protocol.

The user equipment may perform a DNS query to retrieve a list of P-CSCF IP addresses from which one is selected. If the response does not contain any IP addresses, an additional DNS query may be needed to resolve a Fully Qualified Domain Name (FQDN) to an IP address. In a response each P-CSCF may be identified by its host domain name. The returned Resource Records (RRs) may be merged and ordered, and an appropriate selection technique may be used to select a P-CSCF. If the response contains the IP address of the selected P-CSCF, a new query to the DNS is not required.

In the second exemplifying discovery mechanism Proxy-CSCF address information is obtained from PDP context activation signalling. In a more particular example, existing GPRS procedures may be used for P-CSCF discovery such that the procedure for establishment of an appropriate PDP context for IM subsystem signalling is used for the discovery purposes. In the first stage of this procedure a PDP context request is sent from the user equipment to a SGSN. The user equipment may indicate in this message that it also wants to have P-CSCF IP address information. The PDP context request is then sent further from the SGSN to an appropriate GGSN. The GGSN is capable of obtaining at least one IP address of at least one P-CSCF. The mechanism to do this is a matter of internal configuration of each network. A PDP Context Response including the address information is then sent from the GGSN to the SGSN. An activate PDP context accept message including the requested address information may then be sent from the SGSN to the user equipment.

The UE can freely decide which mechanisms it will use to acquire P-CSCF address information. If several P-CSCF addresses are provided to a user equipment without any sufficient priority indications, the user equipment may select an address in based on an appropriate criteria. The selection of a P-CSCF address is an implementation specific issue.

After a new proxy server, e.g. P-CSCF 37 in FIG. 1, has been found and selected, it is assigned for the user equipment. The user equipment may register itself to the up and running P-CSCF 37 and to the S-CSFC 36.

The procedure of transferring from a proxy controller to another may be automatic, and thus user would not necessarily notice the temporary communication failure for non-real time services. For real time services a temporary failure may be noticed. This may occur for example since as ongoing dialogs need to be terminated and reinitiated.

The messaging may be based on the session initiation protocol (SIP). SIP was generally developed to allow for initiating a session between two or more endpoints in the Internet by making these endpoints aware of the session semantics. A user connected to a SIP based communication system may communicate with various entities of the communication system based on standardised SIP messages. User equipment or users that run certain applications on the user equipment are registered with the SIP backbone so that an invitation to a particular session can be correctly delivered to these endpoints. To achieve this, SIP provides a registration mechanism for devices and users, and it applies mechanisms such as location servers and registrars to route the session invitations appropriately. Examples of the possible sessions include Internet multimedia conferences, Internet telephone calls, and multimedia distribution.

If SIP messaging is used, a user equipment 30 requesting for registration sends a SIP ‘REGISTER’ message via the IMS system to the P-CSCF 35 and then to the S-CSCF 36. The acknowledgements may be SIP ‘200 OK’ messages. Notifications may be delivered as SIP ‘NOTIFY’ messages.

It should be appreciated that whilst embodiments of the present invention have been described in relation to user equipment such as mobile stations, embodiments of the present invention are applicable to any other type of equipment that needs to be authenticated.

The examples of the invention have been described in the context of an IMS system and GPRS networks. However, this invention is also applicable to any other standards. Furthermore, the given examples are described in the context of the so called all SIP networks with all SIP entities and communication channels known as PDP contexts. This invention is also applicable to any other appropriate communication systems, either wireless or fixed line systems, communication standards and communication protocols.

Examples of other possible communication systems enabling wireless data communication services, without limiting to these, include third generation mobile communication system such as the Universal Mobile Telecommunication System (UMTS), i-phone or CDMA2000 and the Terrestrial Trunked Radio (TETRA) system, the Enhanced Data rate for GSM Evolution (EDGE) mobile data network. Examples of fixed line systems include the diverse broadband techniques providing Internet access for users in different locations, such as at home and offices. Regardless the standards and protocols used for the communication network, the invention can be applied in all communication networks wherein registration in a network entity is required.

The embodiment of the invention have been discussed in the context of proxy and servicing call state control functions. Embodiments of the invention can be applicable to other network elements where applicable.

It is also noted herein that while the above describes exemplifying embodiments of the invention, there are several variations and modifications which may be made to the disclosed solution without departing from the scope of the invention as defined in the appended claims.

1. A method, in a communication system comprising a serving entity, for providing services to at least one user, and in which access to said serving entity is established via an intermediate entity, the method comprising:
registering a user with the serving entity; and
selectively de-registering said user from the serving entity under the control of the intermediate entity.

2. The method according to claim 1, wherein the step of selectively de-registering said user further comprises transmitting a de-registration message from the intermediate entity to the serving entity.

3. The method according to claim 2, further comprising:
removing the registration of the user from the serving entity, using the serving entity, in response to the de-registration message.

4. The method according to claim 3, further comprising:
transmitting an acknowledgment to the intermediate entity from the server entity in response to removal of the registration from the server entity.

5. The method according to claim 1, further comprising the step of:
following the registration of the user with the serving entity;
receiving confirmation of such registration at the intermediate entity; and
initiating registration of the user at the intermediate entity in response to receiving the confirmation, wherein the step of selectively de-registering said user is enabled upon a failed registration with the intermediate entity.

6. The method according to claim 5, further comprising:
transmitting, from the intermediate element, a message to the user indicating a failed registration in response to enabling the step of selectively de-registering said user.

7. The method according to claim 5, further comprising the step of:
enabling the step of selectively de-registering said user, following successful registration with the intermediate entity, pursuant to a determination that the user's registration at the intermediate entity is to be terminated.

8. The method according to claim 7, wherein, in said enabling step, said determination is dependent upon a local change in a network with which the intermediate element is associated.

9. The method according to claim 7, further comprising the step of:
transmitting a de-registration message to the serving entity, from the intermediate element, in response to said enabling step.

10. The method according to claim 9, further comprising the step of:
de-registering the user using the serving entity in response to the transmitting the de-registration message step.

11. The method according to claim 9, further comprising the step of:
transmitting a notification of de-registration to the user, using the serving entity, in response to the transmitting the de-registration message step.

12. The method according to claim 11, further comprising the step of:
receiving an acknowledgement from the user, at the serving entity, in response to the transmitting the notification step.

13. The method according to claim 12, further comprising:
transmitting an acknowledgement of de-registration to the intermediate entity, from the serving entity, in response to the step of receiving an acknowledgement from the user.

14. The method according to claim 1, further comprising the step of:
providing a proxy call session control function as the intermediate entity and a serving call session control function as the serving entity.

15. The method according to claim 14, further comprising the step of:
using session initiation protocol messages as messages between the intermediate element and the serving element.

16. The method according to claim 7, wherein, in the step of enabling the step of selectively de-registering said user, the determination that the user's registration at the intermediate entity is to be terminated determines termination of a plurality of user's registration.

17. The method according to claim 2, wherein the step of registering the user with the serving entity includes a step of receiving a registration request from the intermediate entity at the serving entity, the de-registering step being dependent upon said de-registration message and said registration message originating from the same intermediate entity.

18. An intermediate entity for a communication system comprising a serving entity for providing services to at least one user, and in which access to said serving entity is established via the intermediate entity, the intermediate entity comprising:
determining means for determining non-registration of a user at the intermediate entity; and
first transmitting means for transmitting a de-registration message to the serving entity responsive thereto.

19. The intermediate entity according to claim 18, further comprising:
receiving means for receiving confirmation of the registration of the user from the serving entity; and
initiating means, responsive thereto, to initiate registration of the user with the intermediate element, wherein said determining means for determining non-registration of a user is responsive to failure of said initiated registration.

20. The intermediate entity according to claim 19, further comprising:
second transmitting means for transmitting a registration failure message to the user responsive to the failure of said initiated registration.

21. The intermediate entity according to claim 18, further comprising:
receiving means for receiving, at the intermediate node, a notification to de-register the user from the intermediate node, wherein said determining means for determining non-registration of a user is responsive to said notification.

22. The intermediate entity according to claim 18, further comprising:
a proxy call session control function, wherein said function is operably connected to said determining means.

23. A communication system comprising:
at least one serving entity for providing services to at least one user; and
at least one intermediate entity for providing access to said at least one server entity for said at least one user, the intermediate entity being adapted to initiate de-registration of the user in the serving entity.

24. The communication system according to claim 23, wherein said intermediate entity is adapted to initiate de-registration of the user in the serving entity responsive to a failed registration of the user in the intermediate entity.

25. The communication system according to claim 23, wherein said intermediate entity is adapted to initiate de-registration of the user in the serving entity responsive to a decision to terminate the registration of the user in the intermediate entity.

26. The communication system according to claim 25, wherein said intermediate server is adapted to receive said decision from a network control element.

27. The communication system according to claim 26, wherein said intermediate element and said serving entity belong to different networks.

28. The communication system according to claim 23, wherein said intermediate element comprises a proxy call session control function and said serving entity comprises a serving call state control function.

29. A method in a communication system comprising at least one user and a serving entity for said user, wherein a connection between said user and said serving entity is established via an intermediate entity, the method comprising:
transmitting a registration request from the user to the serving entity via the intermediate entity;
registering the user at the serving entity;
transmitting confirmation of the user registration from the serving entity to the intermediate entity; and
transmitting a de-registration message for the user to the serving entity in response to a failed registration at the intermediate entity.

30. The method according to claim 29, further comprising:
transmitting an indication of unsuccessful registration to the user in response to a failed registration at the intermediate entity.

31. A method in a communication system comprising at least one user and a serving entity for said user, wherein a connection between said user and said serving entity is established via an intermediate entity, the method comprising:
establishing a registration for the user at the serving entity via the intermediate entity;
determining, at the intermediate entity, that the user's registration is to be terminated; and
transmitting a de-registration message for the user from the intermediate entity to the serving entity.

32. The method according to claim 31, further comprising:
transmitting a notification of the de-registration to the user from the serving entity in response to the de-registration message.

33. The method according to claim 31, further comprising:
transmitting a notification of the de-registration to the intermediate entity from the serving entity in response to the de-registration message to the user.

34. A communication system comprising a serving entity, for providing services to at least on user, and in which access to said serving entity is established via an intermediate entity, the system further comprising:
registering means for registering a user with the serving entity; and
de-registering means for selectively de-registering said user from the serving entity under the control of the intermediate entity.

35. A communication system comprising a serving entity, for providing services to at least on user, and in which access to said serving entity is established via an intermediate entity, the system further comprising:
a processor for registering a user with the serving entity; and
a second processor for selectively deregistering said user from the serving entity under the control of the intermediate entity.

36. An intermediate entity for a communication system comprising a serving entity for providing services to at least one user, and in which access to said serving entity is established via the intermediate entity, the intermediate entity comprising:
a first processor for determining non-registration of a user at the intermediate entity; and
a second processor for transmitting a de-registration message to the serving entity responsive thereto.

37. A communication system comprising:
at least one serving means for providing services to at least one user; and
at least one access means for providing access to said at least one serving means for said at least one user, the providing means being adapted to initiate de-registration of the user and the serving means.

38. A communication system comprising at least one user and a serving entity for said user, wherein a connection between said user and said serving entity is established via an intermediate entity, the system comprising:
first transmitting means for transmitting a registration request from the user from to the serving entity via the intermediate entity;
registering means for registering the user at the serving entity;
second transmitting means for transmitting confirmation of the user registration from the serving entity to the intermediate entity; and
third transmitting means for transmitting a de-registration message for the user to the serving entity in response to a failed registration at the intermediate entity.

39. A communication system comprising at least one user and a serving entity for said user, wherein a connection between said user and said serving entity is established via an intermediate entity, the system comprising:
a first processor for transmitting a registration request from the user to the serving entity via the intermediate entity;
a second processor for registering a user at the serving entity;
a third processor for transmitting confirmation at the user registration from the serving entity to the intermediate entity; and
a fourth processor for transmitting a de-registration message or the user to the serving entity in response to a failed registration at the intermediate entity.

40. A communication system comprising at least one user and a serving entity for said user, wherein a connection between said user and said serving entity is established via an intermediate entity, the system comprising:
establishing means for establishing a registration for the user at the serving entity via the intermediate entity;
determining means for determining, at the intermediate entity, that the user's registration is to be terminated; and
transmitting means for transmitting a de-registration message for the user from the intermediate entity to the serving entity.

41. A communication system comprising at least one user and a serving entity for said user, wherein a connection between said user and said serving entity is established via an intermediate entity, the system comprising:
a first processor for establishing a registration for the user at the serving entity via the intermediate entity;
a second processor for determining, at the intermediate entity, that the user's registration is to be terminated; and
a third processor for transmitting a de-registration message for the user from the intermediate entity to the serving entity.
